(19) United States
(12) Patent Application Publication
(10) Pub. No.: US 2002/0152653 A1
(43) Pub. Date: Oct. 24, 2002

(54) Knockdown license plate frame and decorative articles thereof

(76) Inventor: Shun-Tian Shuen, San Chung City (TW)

Correspondence Address: BACON & THOMAS, PLLC, 625 Slaters Lane, 4th Floor, Alexandria, VA, 22314-1176, US

(21) Appl. No.: 09/837,473

(22) Filed: Apr. 19, 2001

(51) Int. Cl. G09F 7/00

(52) U.S. Cl. 40/209

(57) ABSTRACT

Knockdown license plate frame structure and decorative articles thereof. The decorative articles serve to shade the tightening members for locking the license plate frame. The license plate frame has several locating plate each having a locating hole. Each of the decorative articles is formed with pivot holes corresponding to the locating holes. The tightening members are screwed into the pivot holes of the decorative articles and the locating holes of the license plate frame to easily replaceably lock the decorative articles with the license plate frame to achieve a decorative and beautifying effect.

### BACKGROUND OF THE INVENTION

The present invention relates to a knockdown license plate frame and decorative articles thereof. The license plate frame is easily replaceable and is not subject to damage. The license plate frame is designed with various patterns to achieve a decorative and beautifying effect.

A conventional license plate frame is provided with locating plates on the corners. Each locating plate is formed with a circular through hole. A screw is screwed into the through hole for locking the license plate on the license plate frame and the car body. The locating plates are exposed to sunlight and rain so that after a long period of use, the locating plates are subject to rusting to deteriorate the appearance of the license plate frame. Moreover, the rusting locating plates maybe broken due to shock during running. This will make the license plate frame drop down and lead to danger in running.

In addition, the conventional license plate frame has monotonous pattern and has single fixed function.

### SUMMARY OF THE INVENTION

It is therefore a primary object of the present invention to provide a knockdown license plate frame structure and decorative articles thereof. The decorative articles serve to shade the tightening members for locking the license plate frame and protective the locating plates thereof from being damaged.

It is a further object of the present invention to provide the above knockdown license plate frame structure and decorative articles thereof. The decorative articles can be easily replaceably locked with the license plate frame to achieve a decorative and beautifying effect.

According to the above objects, the decorative articles of the present invention serve to shade the tightening members for locking the license plate frame. The decorative article is composed of a decorative cover formed with pivot holes corresponding to the locating holes of the license plate frame. The tightening members are screwed into the pivot holes of the decorative cover and the locating holes of the locating plate to easily replaceably lock the decorative articles with the license plate frame to achieve a decorative and beautifying effect.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a perspective assembled view of the first embodiment of the present invention;

FIG. 3 shows the application of the first embodiment of the present invention to a license plate of a car;

FIG. 4 is a perspective exploded view of a second embodiment of the present invention;

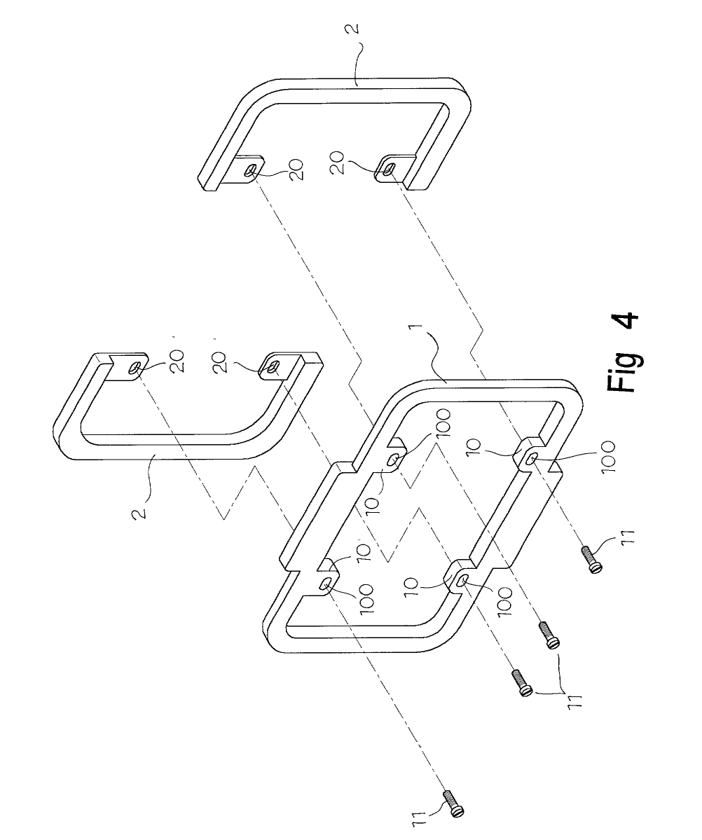

FIG. 5 is a perspective assembled view of the second embodiment of the present invention; and

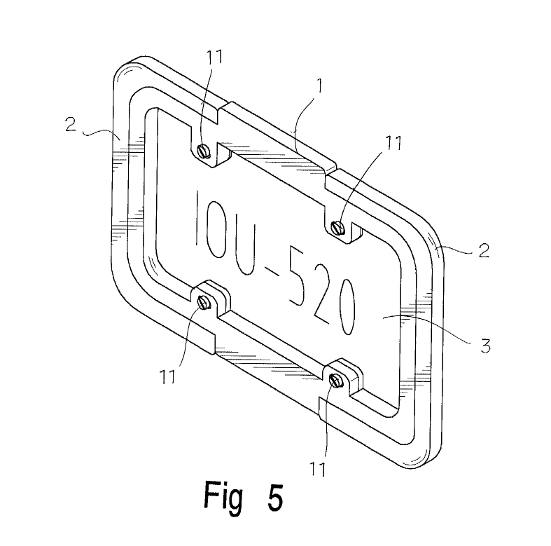

FIG. 6 shows the application of the second embodiment of the present invention to a license plate of a car.

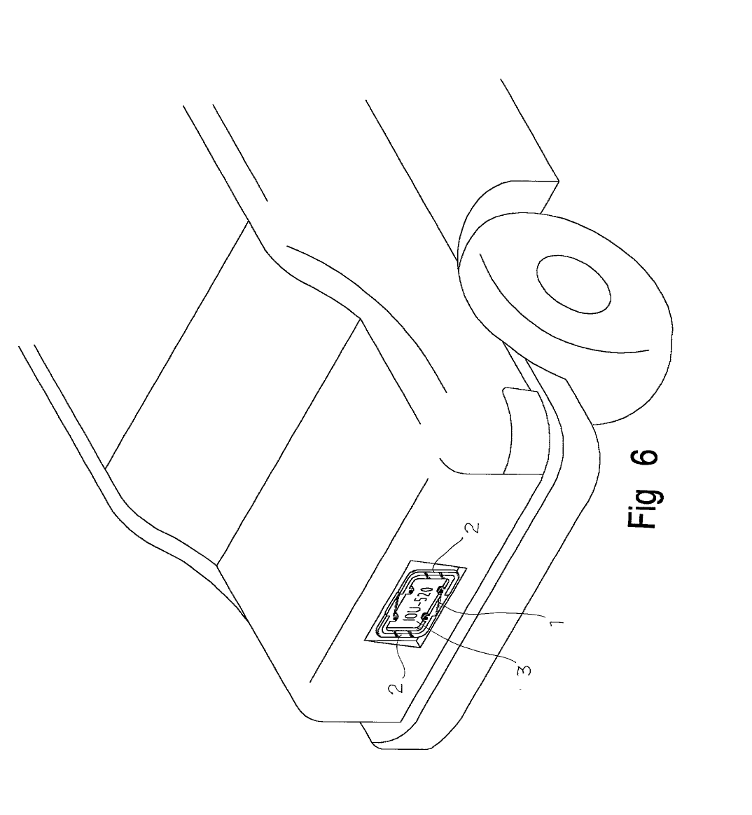

### DETAILED DESCRIPTION OF THE PREFERRED EMBODIMENTS

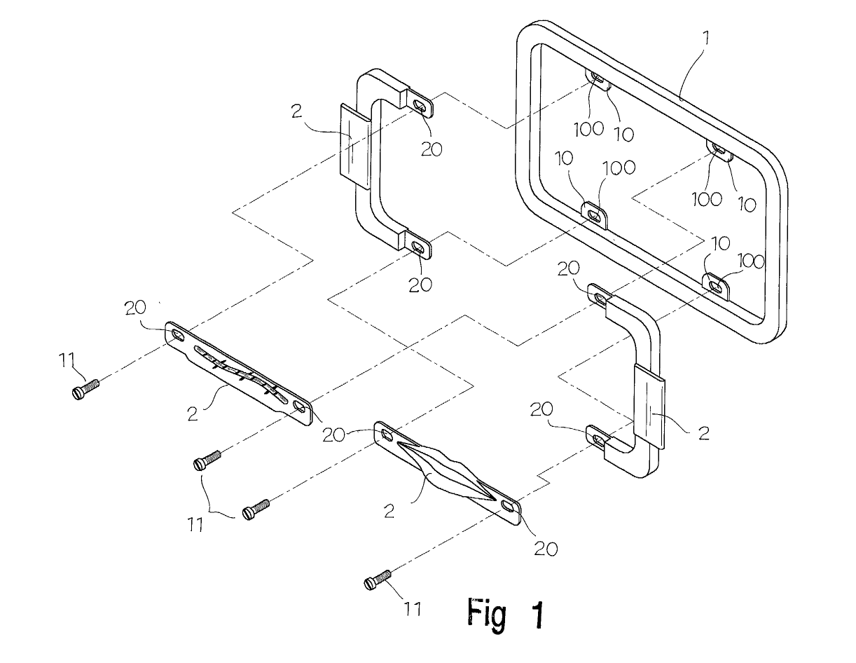

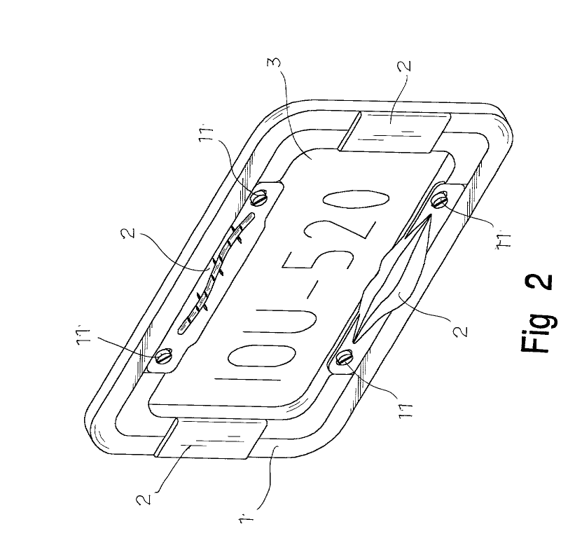

Please refer to FIGS. 1 and 2. The present invention includes a license plate frame 1 and multiple decorative articles 2 thereof. The license plate frame 1 is a hollow rectangular frame body similar to a conventional one. The inner side of the frame body is formed with several locating plates 10 each having a locating hole 100. The decorative article 2 is also a rectangular body formed with pivot holes 20 corresponding to the locating holes of the license plate frame 1.

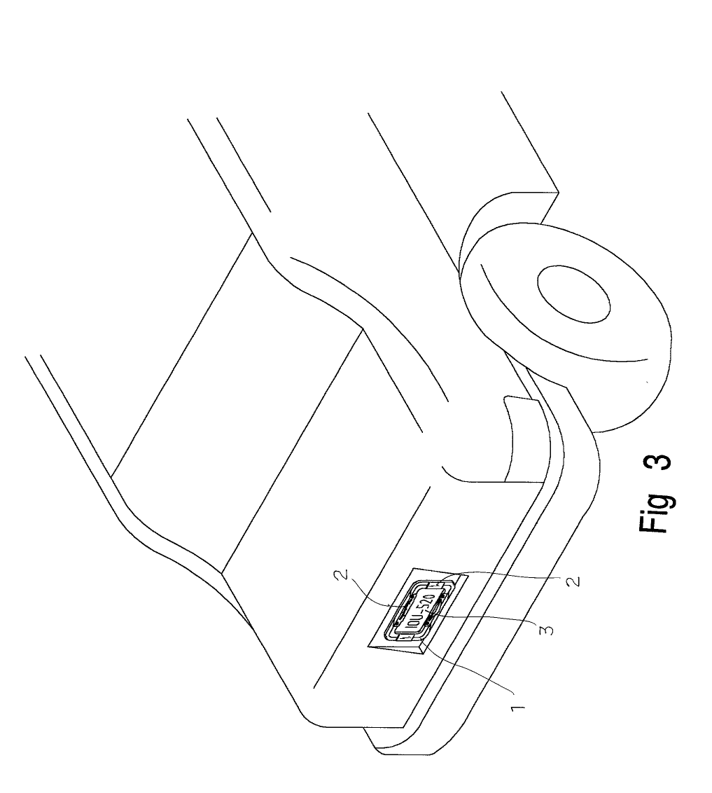

In use, the license plate frame 1 is first locked with the license plate 3 of a general car or motorcycle. Then the decorative articles 2 are respectively fixed at the locating holes 100 of the locating plates 10 of the license plate frame 1 by locking screws 11 to form a beautifying decorative license plate frame structure as shown in FIG. 3.

Please refer to Pigs. 4 to 6 which show another embodiment of the license plate frame 1 and the decorative articles 2 thereof. The license plate frame 1 is a hollow rectangular frame body having locating plates 10 each having a locating hole 100 for locking with the decorative articles 2. The decorative article 2 is composed of two opposite U-shaped frame bodies spaced from each other. The decorative article 2 is formed with pivot holes 20 corresponding to the locating holes of the locating plates 10 of the license plate frame 1. In use, the license plate frame 1 is first aligned with and locked with the license plate 3. Then the locking screws 11 are screwed into the pivot holes 20 of the decorative articles 2 and the locating holes 100 of the locating plates 10 of the license plate frame 1.

The license plate frame 1 and the decorative articles 2 thereof are not limited to one single specific pattern. Instead, the license plate frame 1 and the decorative articles 2 can be freely designed with various live patterns and replaceably assembled with each other to highlight personal styles and achieve a beautifying effect.

Furthermore, the decorative articles can shade the locating plates of the license plate frame and can be easily assembled or disassembled so that it is easy to replace the decorative article with another.

The above embodiments are only used to illustrate the present invention, not intended to limit the scope thereof. Many modifications of the above embodiments can be made without departing from the spirit of the present invention.

What is claimed is:

1. Knockdown license plate frame structure and decorative articles thereof, comprising:
a license plate frame which is a hollow rectangular frame body, an inner side of the frame body being formed with several locating plates each having a locating through hole; and
decorative articles each of which is composed of a decorative cover formed with pivot holes corresponding to the locating holes of the license plate frame, whereby tightening members are screwed into the pivot holes of the decorative cover and the locating holes of the locating plate to easily replaceably lock the decorative articles with the license plate frame to achieve a decorative and beautifying effect.

2. Knockdown license plate frame structure and decorative articles thereof as claimed in claim 1, wherein the decorative article is composed of two opposite U-shaped frame bodies spaced from each other.

3. Knockdown license plate frame structure and decorative articles thereof as claimed in claim 1, wherein the license plate frame is a hollow rectangular frame body, middle portions of upper and lower sides of the frame body slightly projecting from the frame body, whereby the U-shaped decorative articles can be integrally connected with the license plate frame.
